(19) United States
(12) Patent Application Publication
(10) Pub. No.: US 2008/0110580 A1
(43) Pub. Date: May 15, 2008

(54) INSULATED CURTAIN FOR A DOOR

(75) Inventors: Bill Hoerner, Dubuque, IA (US); Peter S. Schulte, East Dubuque, IL (US)

Correspondence Address: HANLEY, FLIGHT & ZIMMERMAN, LLC, 150 S. WACKER DRIVE, SUITE 2100, CHICAGO, IL, 60606, US

(73) Assignee: RITE-HITE HOLDING CORPORATION, Milwaukee, WI (US)

(21) Appl. No.: 11/559,733

(22) Filed: Nov. 14, 2006

(51) Int. Cl. E06B 3/48

(52) U.S. Cl. 160/113

(57) ABSTRACT

A vertically operating door includes a flexible panel comprising two pliable sheets of material with a layer of thermal insulation between the two. The door includes means for preventing or relieving undesirable air pressure conditions inside the panel. In some cases, a hose from a suction inlet of a blower extends into the space between the two sheets so that when the door is closed with the bottom of the panel resting upon the floor, the blower draws out excess air that happens to leak into the hollow interior of the panel. In other cases, air passageways are created to release or redistribute the excess air inside the panel. The door includes an inflatable seal that helps prevent frost from forming on the door panel's vertical guide tracks, thus the door is particularly suited for refrigerated cold storage rooms.

### FIELD OF THE DISCLOSURE

The present disclosure generally pertains to an insulated door and more specifically to a door that includes a flexible curtain.

### BACKGROUND OF RELATED ART

Cold storage rooms are refrigerated areas in a building that are commonly used for storing perishable foods. Cold storage rooms are typically large enough for forklifts and other material handling equipment to enter. Access to the room is often through a power actuated insulated door that separates the room from the rest of the building. To minimize thermal losses when someone enters or leaves the room, the door preferably opens and closes as quickly as possible.

Vertically operating roll-up doors and similar doors with flexible curtains are perhaps some of the fastest operating doors available. When such a door opens, its curtain usually bends upon traveling from its closed position in front of the doorway to its open position on an overhead storage track or take-up roller.

Such bending is not a problem if the curtain is relatively thin; however, an insulated curtain might not bend as well due to the required thickness of the insulation. When a take-up roller or curved track bends a thick curtain, relative translation may occur between opposite faces of the curtain. Designing a thick, insulated curtain that can accommodate such translation can be challenging.

Moreover, if an insulated curtain becomes temporarily creased or locally compressed along the horizontal line where the curtain bends, such a crease or compression might trap a pocket of air inside the curtain, and that trapped air might adversely affect the door's operation or the curtain's insulating properties.

Consequently, a need exists for a fast vertically operating door with a thick, insulated curtain that is preferably not subject to the limitations indicated above.

### SUMMARY

In some embodiments, a vertically operating door includes an insulated curtain, wherein the door includes means for preventing or relieving undesirable air pressure conditions inside the curtain.

In some embodiments, a pump evacuates excess air from within an insulated, flexible door curtain.

In some embodiments, a check valve exhausts excess air from within an insulated, flexible door curtain.

In some embodiments, an insulated, flexible door curtain includes ribs or other internal structures that create air passageways within the curtain, wherein the air passageways help redistribute air inside the curtain as the door opens.

In some embodiments, a vertically operating door includes a laminated, insulated curtain, wherein a layer of insulation is adhesively bonded in place such that the insulation and an external face of the curtain can translate relative to one or more other layers of the curtain.

In some embodiments, a vertically operating door includes a roller whose outer perimeter includes one or more reduced-diameter sections that permit air to redistribute itself within an insulated curtain that passes over the roller.

In some embodiments, a vertically operating door with an insulated, flexible curtain includes an inflatable seal. The inflatable seal exhausts some air against the curtain's guide tracks to inhibit frost from accumulating on the tracks.

In some embodiments, an insulated, flexible curtain suspends an internal weight near the bottom of the curtain such that the weight helps flatten the curtain when the door is closed.

### BRIEF DESCRIPTION OF THE DRAWINGS

FIG. 1 is a front view of a door shown in a closed position.

FIG. 2 is a front view similar to FIG. 1 but showing the door partially open.

FIG. 3 is a front view similar to FIGS. 1 and 2 but showing the door fully open.

FIG. 4 is a cross-sectional view taken along line 4-4 of FIG. 3.

FIG. 5 is a cross-sectional view taken along line 5-5 of FIG. 1.

FIG. 6 is a cross-sectional view similar to FIG. 5 but showing the door slightly open.

FIG. 7 is a schematic view of a door closing.

FIG. 8 is a schematic view of the door immediately after closing.

FIG. 9 is a schematic view of the door after it has been closed for awhile.

FIG. 10 is a schematic view of the door as opens.

FIG. 11 is a schematic view of the door fully open.

FIG. 12 is a front view a door panel.

FIG. 13 is a cross-sectional side view taken along line 13-13 of FIG. 12.

FIG. 14 is a top cross-sectional view taken along line 14-14 of FIG. 12.

FIG. 15 is a cross-sectional view similar to FIG. 13 but showing an alternate embodiment.

FIG. 16 is a cross-sectional view similar to FIG. 14 but showing an alternate embodiment.

FIG. 17 is a cross-sectional view similar to FIG. 13 but showing an embodiment that includes a check valve.

FIG. 18 is a cross-sectional view similar to FIG. 17 but showing the check valve open.

FIG. 19 is a cross-sectional view similar to FIG. 13 but showing another embodiment.

FIG. 20 is a cross-sectional view similar to FIG. 19 but showing the panel in a closed position resting upon the floor.

FIG. 21 is a front view similar to FIG. 2 but showing the door with a different roller.

FIG. 22 is a cross-sectional view taken along line 22-22 of FIG. 1.

FIG. 23 is a cross-sectional view taken along line 23-23 of FIG. 2.

### DETAILED DESCRIPTION

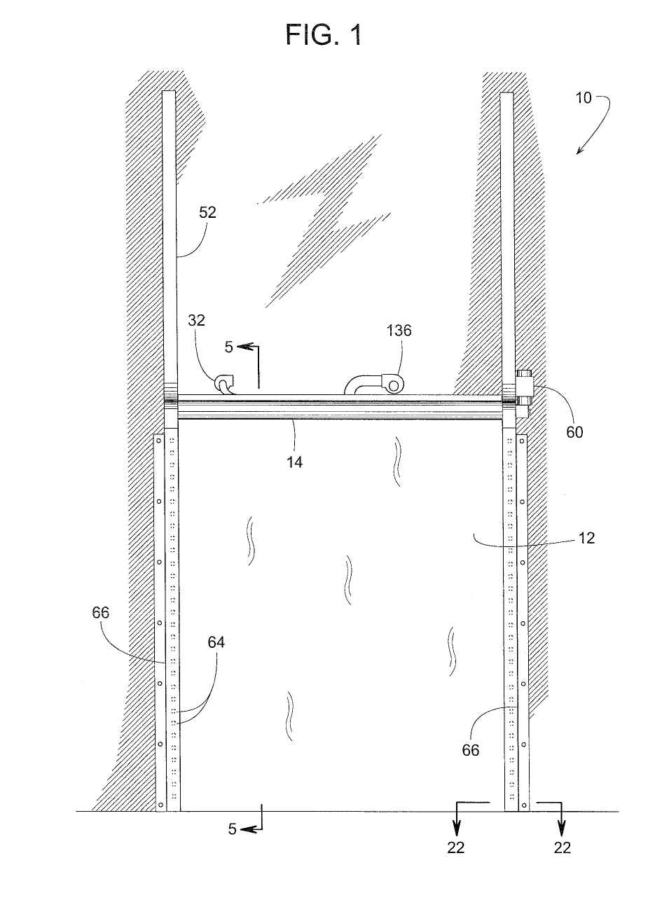

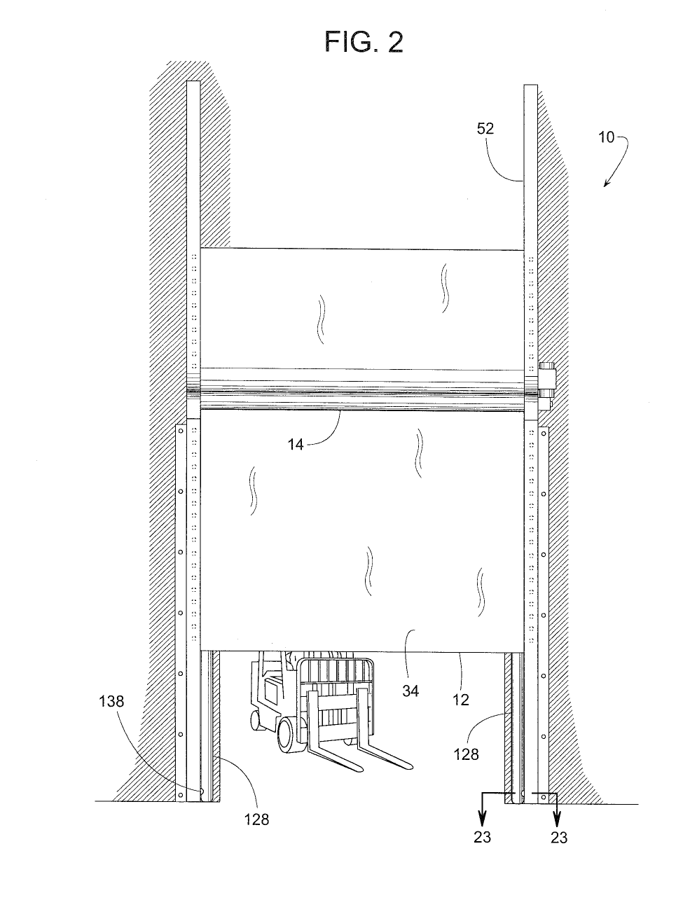

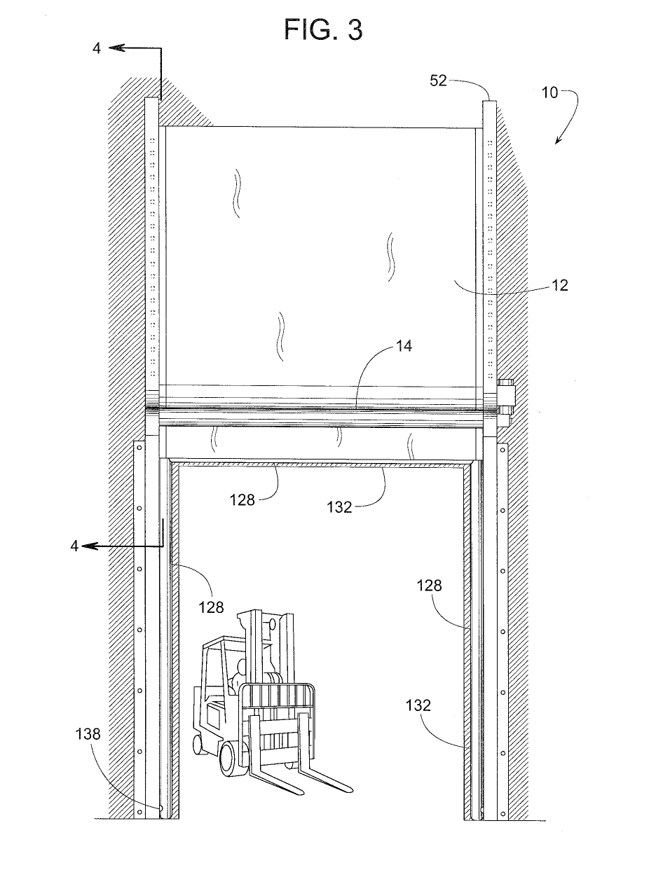

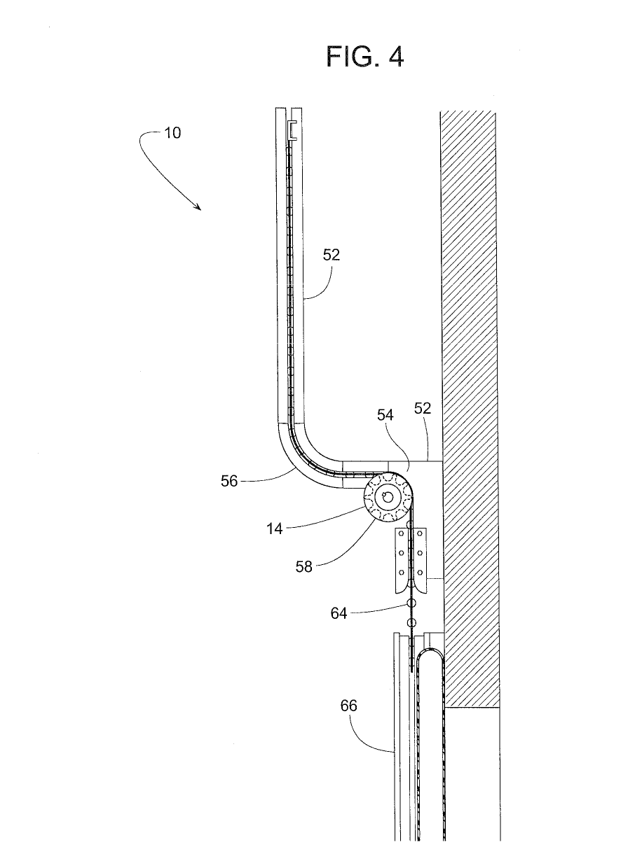

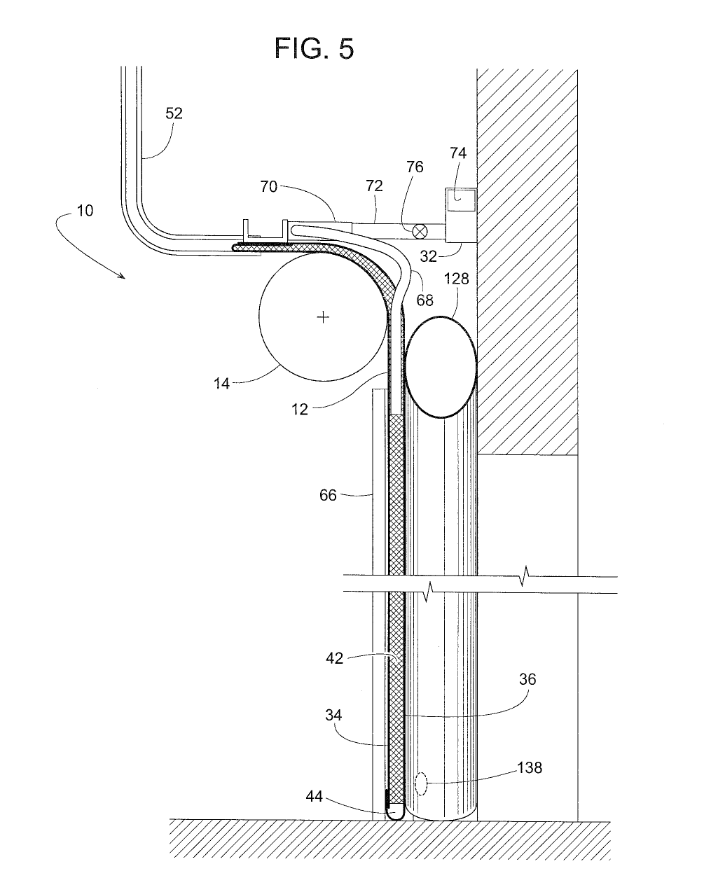

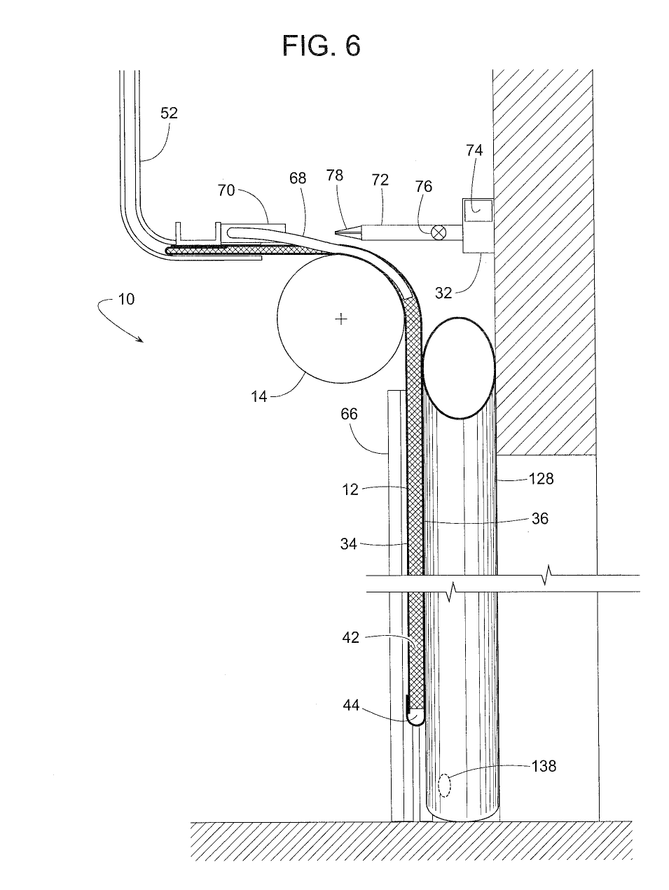

FIGS. 1-6 illustrate a vertically operating door 10 that includes a flexible, insulated door panel 12 with means for handling or avoiding undesirable air pressure conditions inside the panel. Door 10 is shown open in FIGS. 3 and 4, closed in FIGS. 1 and 5, and partially open in FIGS. 2 and 6. As door 10 opens and closes, panel 12 bends over a support roller 14, which contributes to the air pressure problem that is addressed by the present disclosure. Although panel 12 is shown having a certain double-bend, stored configuration, other stored configurations, such as coiled, single-bend horizontal, serpentine, vertically planar, etc., may be utilized as well. Door 10 is particularly suited for a cold storage room; however, door 10 could also be applied to various other applications as well.

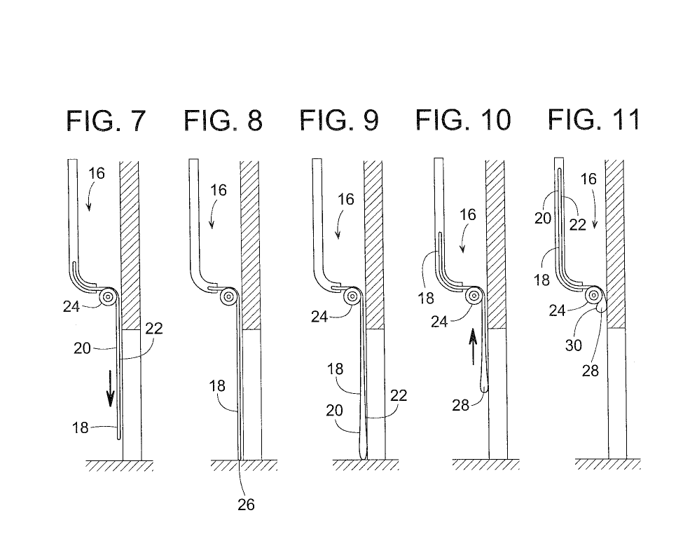

To understand the reasoning behind the design of door 10, refer to FIGS. 7-11 as these figures schematically illustrate the operating sequence of a door 16 and the underlying problem that can arise with an insulated door panel 18 that bends as door 16 opens and closes. In the illustrative example, panel 18 comprises a layer of porous insulation (and air) sandwiched between a first pliable sheet 20 and a second pliable sheet 22. Although the insulation and the air is almost hermetically sealed within the outer perimeter of sheets 20 and 22, some air leakage in and out of panel 18 can occur.

As door 16 closes, as shown in FIG. 7, panel 18 bends over a roller 24 that can be used for supporting panel 18 and possibly driving panel 18 between its open and closed positions. FIG. 8 shows panel 18 having stopped at its closed position with a bottom edge 26 of panel 18 resting upon the floor. As panel 18 rests there, the panel's weight urges sheets 20 and 22 apart, which reduces the air pressure inside panel 18. Since panel 18 is not absolutely hermetically sealed, the reduced air pressure causes some air to leak slowly into the panel. As panel 18 takes in air, sheets 20 and 22 begin bulging outward, as shown in FIG. 9. Then, if door 16 is suddenly opened, as shown in FIG. 10, the air that had slowly leaked into panel 18 cannot escape before panel 18 is fully raised, as shown in FIG. 11. As panel 18 bends over roller 24, the contact pressure between roller 24 and panel 18 forces sheets 20 and 22 together, thereby trapping a pocket of air 28 (that had previously leaked into the panel) between roller 24 and the bottom edge 26 of panel 18. The pressure of the trapped air 28 can create an unsightly bulge 30 and possible cause the panel to burst or cause other operational problems. Since the absence of structure to prevent or relieve this pressure build-up would be deleterious to the operation and longevity of the door, several embodiments herein disclose differing means for preventing or relieving this pressure build-up. While the various means differ in structure (from pumps, to check valves, to internal air passageways and weighting structures), they share the common beneficial result of allowing door operation without the negative effects of the pressure build-up.

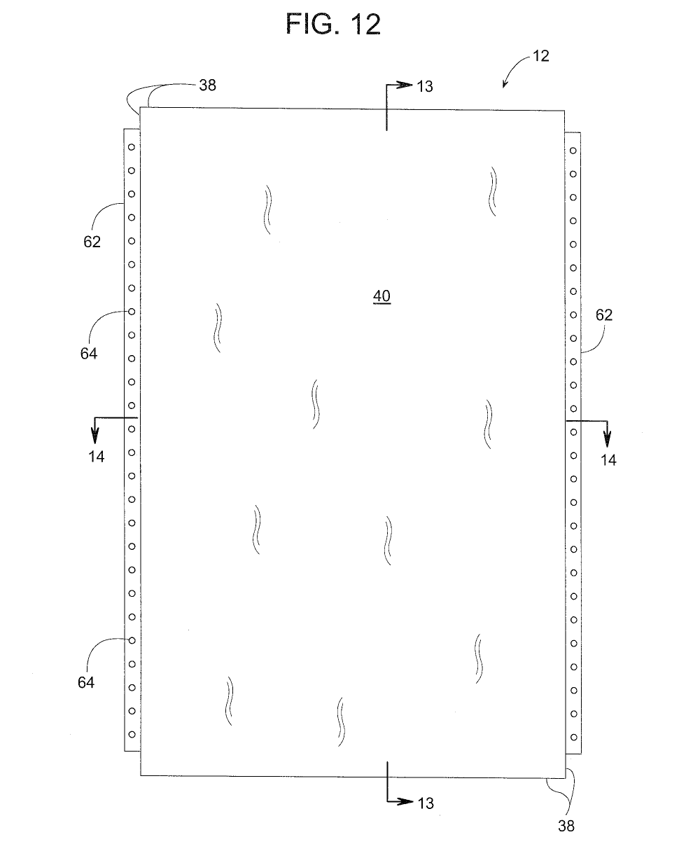

Thus, while various embodiments of the disclosure address the pressure problem in different ways, in one embodiment, a pump in the form of a blower 32 (FIGS. 1, 5 and 6) is the means for preventing or relieving the pressure and is used for drawing excess air out from within panel 12, wherein panel 12 can be constructed as shown in FIGS. 12, 13 and 14. In this example, panel 12 comprises a first pliable sheet 34 and a second pliable sheet 36. The two sheets 34 and 36 are joined to each other along a generally rectangular edge 38 around a generally rectangular central region 40 of the panel. Sheets 34 and 36 can be made of any suitable polymeric or natural fabric material and can be joined by adhesion, tape, melting/welding, sewing, hook-and-loop fastener, snaps, rivets, zipper, etc. A layer of thermal insulation 42, such as a porous foam or polyester mat, is installed within a chamber 44 between sheets 34 and 36.

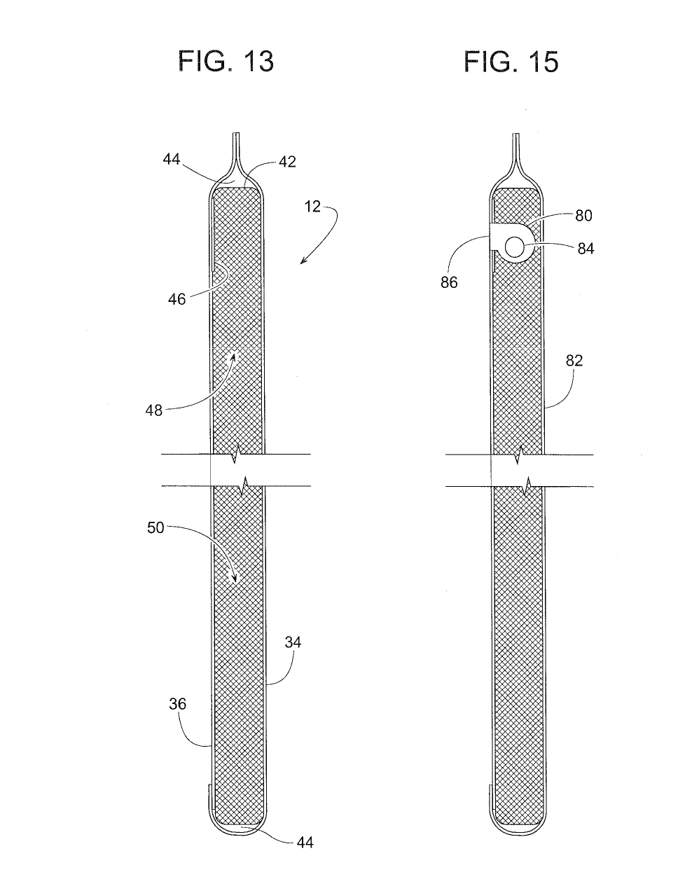

Since some localized translation occurs between sheets 34 and 36 as panel 12 bends over roller 14, consideration needs to be given as to how insulation 42 should be installed between sheets 34 and 36. In short, it is desired that the resulting panel have adequate insulative properties (provided in part by the insulation 42), yet still be capable of bending or rolling for operation/storage purposes—all while maintaining acceptable aesthetics by not bulging or creasing. In one embodiment, insulation 42 is generally suspended from the top of panel 12 so that insulation 42 can tolerate some translation without entirely losing its proper orientation within the panel. A layer of adhesive 46 (FIG. 13), for example, can bond an upper portion of insulation 42 to sheet 36 and/or 34, whereby more of adhesive 46 is on an upper half 48 of insulation 42 than on a lower half 50. That layer can take a variety of shapes (linear, u-shaped, etc) or be several spaced strips. In some cases, adhesive 46 bonds an upper portion of insulation 42 to just the first or second sheet so that insulation 42 is free to translate relative to the other sheet. The connection between the upper portion of insulation 44 and a sheet 36 and or 34 need not be achieved with adhesive, as other bonding methods (sewing, crimping, heat welding, etc) could also be used. This arrangement—in which the insulation 42 is suspended from an upper portion thereof so as to be held in place relative to the sheets 36 and/or 34 but capable of translation relative thereto—helps achieve the goal of a properly insulated panel that can be bent or rolled, yet still retain its aesthetics. A “laminated” panel in which all three layers are bonded together over their planar faces might have good insulative quality—but the stresses induced by bending and rolling could damage or destroy the curtain. Having free—floating insulation might allow it to bunch up and localize—minimizing its insulative effect. This design, then, represents a balance of at least the three factors of insulative value, bendability/rollability and aesthetics.

Although various means could be used for driving panel 12 between its open and closed positions, in one embodiment, one or two sprockets 58 connected to rotate with roller 14 and driven by a motor 60 meshes with one or two drive strips 62 (FIG. 14) that are attached to lateral edges of panel 12. Depending on the rotational direction of motor 60, sprocket 58 engaging a series of protuberances 64 forces panel 12 up or down along a pair a guide tracks 66. Further details of this drive mechanism can be found in U.S. patent application Ser. No. 11/446,679, which is specifically incorporated by reference herein.

Referring to FIGS. 5 and 6, to deal with the problem of air leaking into chamber 44 when door 10 is closed a pump in the form of blower 32 is placed in fluid communication with the chamber 44 for removing air therefrom. As used herein, “pump” is intended as a broad term for a mechanical device that conveys fluid from an inlet to an outlet. One of skill in the art will appreciate that pumps for acting on gasses are typically described as fans or blowers depending on their capacity, power consumption or other characteristics. Use of the terms “pump” and “blower” herein are intended to be exemplary, and not to limit the disclosure to those specific structures. In the examples of FIGS. 5 and 6, a suction hose 68 and a disconnectable coupling 70 places a suction tube 72 of blower 32 in fluid communication with chamber 44 when panel 12 is at its closed position of FIG. 5. In this position, air having leaked into chamber 44 can escape by being drawn sequentially through chamber 44, suction hose 68, coupling 70, and suction tube 72, wherein blower 32 discharges the air back out to atmosphere through a discharge outlet 74 of blower 32. The capacity of blower 32 can be chosen based on the size and leak rate of the panel so that blower 32 can flatten sheets 34 and 36 without completely crushing insulation 42. In some cases, a valve 76 can be added as a quick and easy way for adjusting the blower's effective capacity. While a detailed system has been shown here (hose, coupling, suction tube, blower, discharge tube), one will appreciate that simpler systems placing the pump or blower 32 in fluid communication with chamber 44 to facilitate evacuation thereof are also possible, and the disclosure is not limited to these details.

With blower 32 keeping panel 12 relatively flat when door 10 is closed, the door can later open without a panel-bulging amount of trapped air being inside chamber 44. Since panel 12 is almost airtight, the leak rate is quite small, so door 10 can take a few seconds raising panel 12 without blower 32 having to continuously draw air out from within chamber 44 as panel 12 travels over roller 14, as shown in FIG. 6. Thus, coupling 70, which is attached to the upper end of panel 12, can separate from suction tube 72 whenever panel 12 is not resting upon the floor.

The separation of coupling 70 can be carried out by various means. In some cases, for example, suction tube 72 telescopically slip fits into coupling 70. Tapered fins 78 provide a smooth lead-in that helps guide coupling 70 and suction tube 72 together. To accommodate for axial misalignment, appreciable axial overlap exists between coupling 70 and suction tube 72 when the two are engaged.

As an alternative to blower 32 and coupling 70, a blower 80 can be installed directly to either the outside or inside a door panel 82, as shown in FIG. 15. In this case, a suction inlet 84 of blower 80 draws leaked-in air directly out from within panel 82, and a discharge outlet 86 releases the air to atmosphere. To power blower 80, wires with sufficient flexibility and length can be permanently wired to blower 80, whereby blower 80 could be controlled to run continuously whether the door is open or closed, or a disconnectable electrical coupling (analogous to coupling 70) could be used to convey electrical power to blower 80 only when the door is closed.

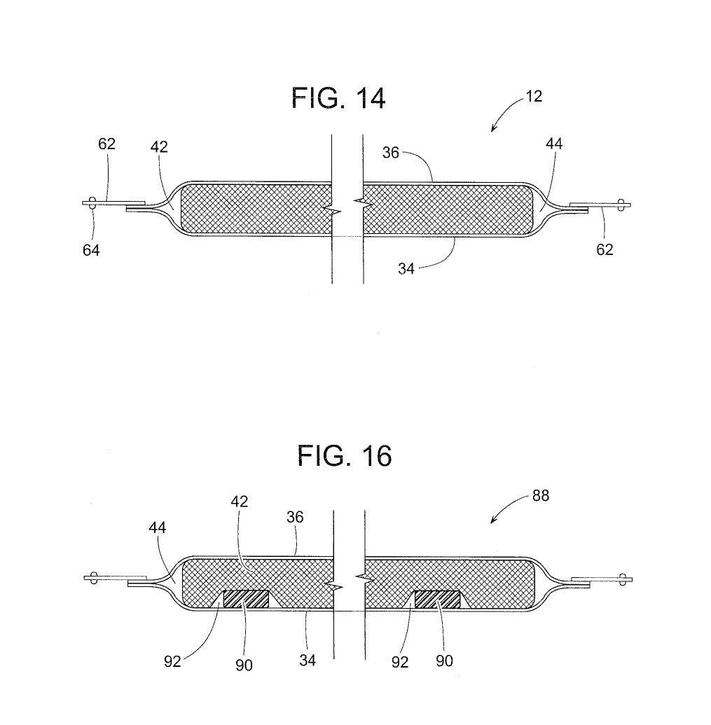

FIGS. 16-21 illustrate various alternatives to using a blower for evacuating excess air from within a door panel as a means for preventing or relieving pressure in the internal chamber of the panel. FIG. 16, for instance, shows a flexible door panel 88 comprising first sheet 34, second sheet 36, insulation 42, and one or more vertically elongate flexible ribs 90 (bar, channel, tube, hose, rod, etc.) disposed within chamber 44. Each rib 90 can be run substantially the full height of panel 88 or extend along a shorter distance. Rib 90 displaces some insulation 42 to create an air passageway 92 therebetween. As the door opens and panel 88 is locally compressed upon passing over roller 14, passageway 92 serves as the means for preventing or relieving pressure by allowing the redistribution of excess air from the bottom of panel 88 to the upper end of panel 88, thereby avoiding the creation of a bulge at the bottom of the panel when the door opens.

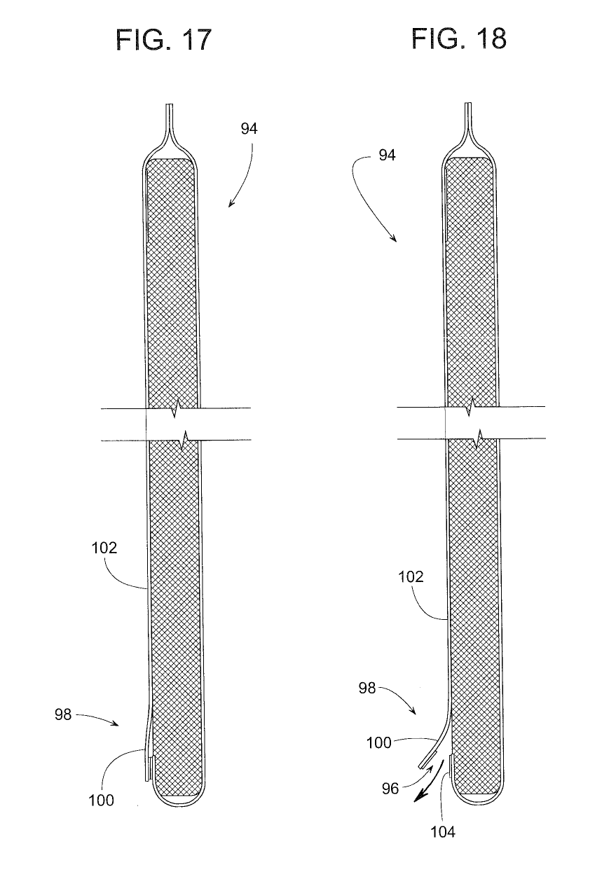

FIGS. 17 and 18 illustrate a panel 94 that can exhaust excess air out through an opening 96 near the bottom of the panel which opening thus serves a the means for preventing or relieving pressure. Opening 96 can be open permanently, or a check valve 98 can be added so that air can leave panel 94 more easily than it can enter. Check valve 98 can take the form of a flap 100 that is an integral part of a first flexible sheet 102 of panel 94. Flap 100 can extend partially or substantially fully across the width or height of panel 94. To ensure a positive closure when check valve 98 closes, magnetic tape 104 can be added along the edges of the valve's opening.

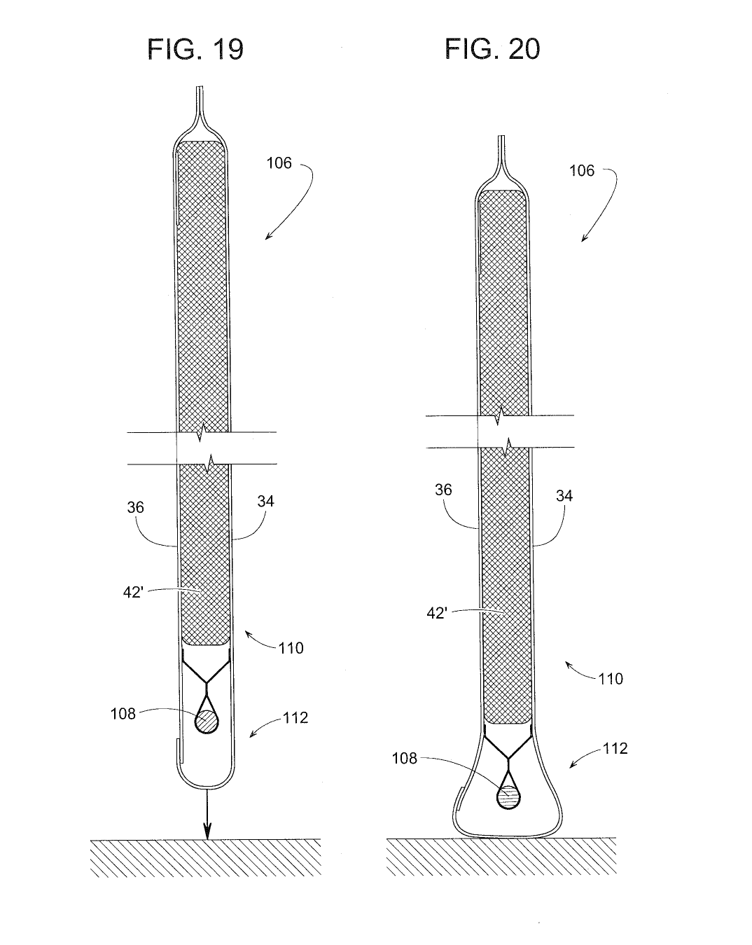

In another embodiment, shown in FIGS. 19 and 20, a door panel 106 comprises first sheet 34, second sheet 36, a layer of insulation 42′, and a mass 108 suspended from sheets 34 and 36. Mass 108 can be any deadweight including, but not limited to, a bar, pipe, rod, or a horizontal rib bonded directly to sheet 34 and/or 36. Mass 108 can be situated between an upper section 110 and a lower section 112 of panel 106 such that when the door is closed, the weight of mass 108 compresses lower section 112 against the floor (FIG. 20) and urges sheets 34 and 36 into straight parallel relationship with each other. The maintenance of the sheets in this generally parallel relationship helps prevent the creation of a negative pressure inside the panel created by the sheets bowing out with the door closed thus allowing the mass to serve as a means for preventing or relieving pressure. It is this negative pressure that would otherwise cause outside air to leak in. Although a weight near the bottom of the door has been shown to disclose this effect, a similar beneficial result (keeping the sheets generally parallel) could also be achieved by having guide tracks 66 (see FIG. 1) that are movable laterally to the doorway to pull the curtain more taut laterally with the door in the closed position.

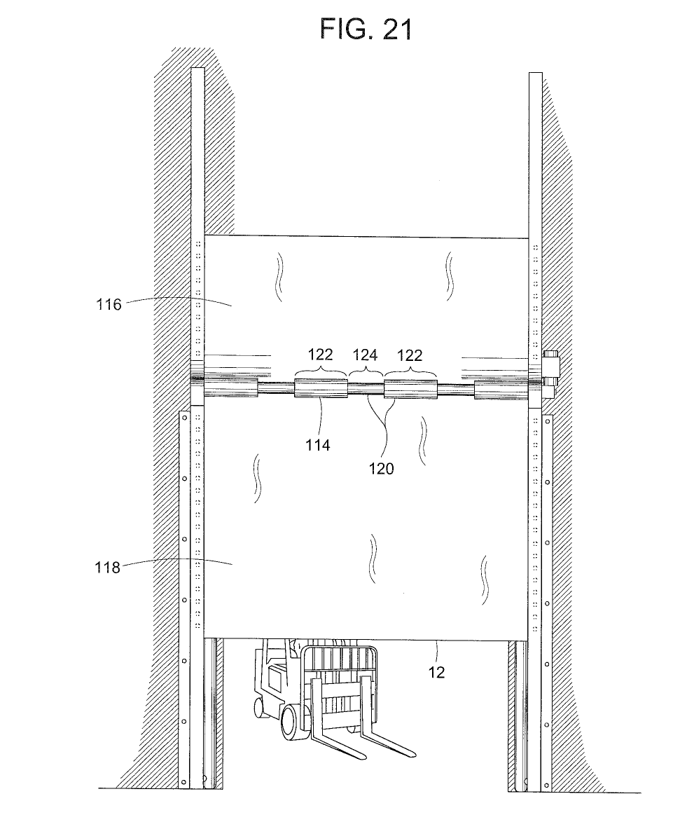

In yet another embodiment, shown in FIG. 21, roller 14 is replaced by a necked-down roller 114 that allows air trapped within door panel 12 to pass between upper and lower panel sections 116 and 118 that are at opposite sides of roller 114. Specifically, roller 114 includes an outer surface 120 that has a major diameter section 122 and a minor diameter section 124, wherein panel 12 becomes compressed more at major diameter section 122 than at minor diameter section 124. As the door opens, air inside lower section 118 can travel to upper section 116 by passing through the interior of the panel near the minor diameter sections 124 that are between major diameter sections 122. In this sense, this embodiment is an analog of the curtain—interior ribs of FIG. 16 and roller 114 thus represents another example of a means for preventing or relieving pressure.

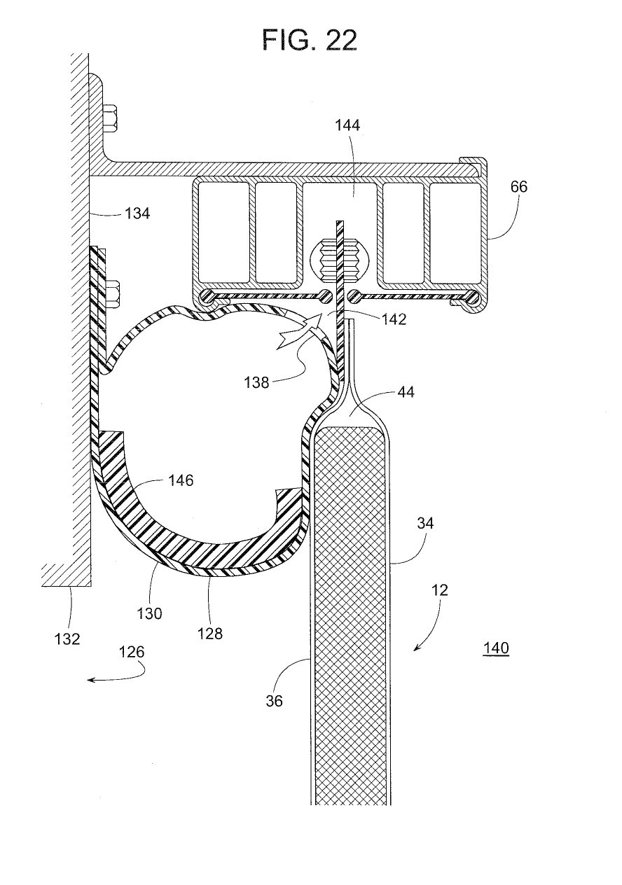

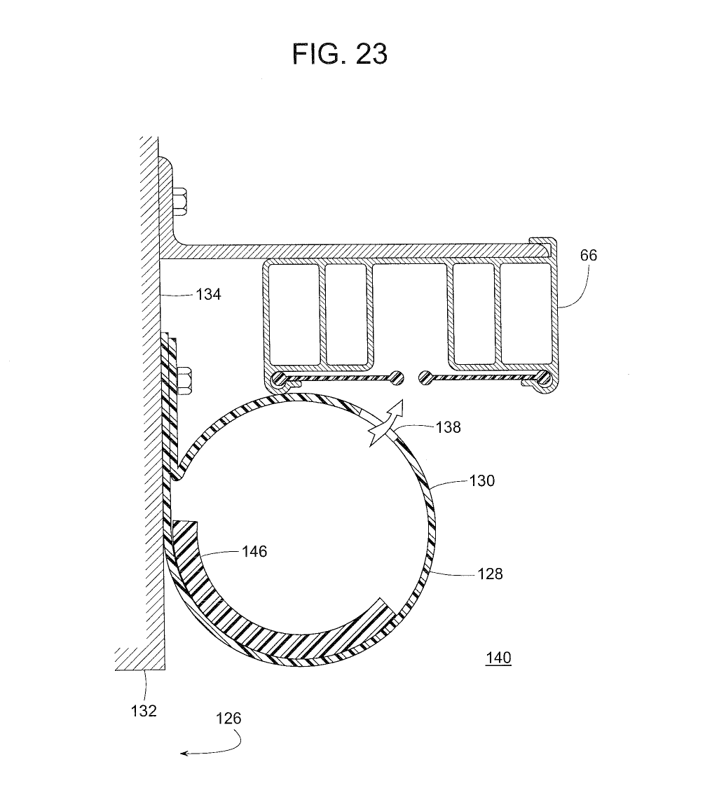

To make door 10 (or the other door embodiments disclosed herein) particularly suited for use at a cold storage room 126, door 10 includes an inflatable seal 128, as best seen in FIGS. 1, 3, 22 and 23. FIG. 22 shows seal 128 when the door is closed, and FIG. 23 shows seal 128 when the door is open. Seal 128 comprises a pliable fabric or polymeric tube 130 that can line the upper and lateral edges of a doorway 132 in a wall 134. A pump in the form of a blower 136 (FIG. 1) inflates tube 130 so that when door 10 is closed, tube 130 sealingly engages panel 12 as shown in FIG. 22. Blower 136 may inflate tube 130 with relatively warm ambient air 140 so that the heat from that air prevents frost from forming on track 66.

The heat can be transferred to track 66 by conduction if tube 130 is in direct contact with track 66, as shown in FIGS. 22 and 23. The heat can also be transferred to track 66 through convection by providing tube 130 with an outlet hole 138 that discharges air 140 from within tube 130 against track 66. Upon exiting hole 138, the relatively warm air can travel along the vertical length of track 66 by passing upward through a first air passageway 142 between tube 130 and track 66 and/or passing upward through a second air passageway 144 defined by track 66.

To minimize heat transfer between the air in cold storage room 126 and the relatively warm air in tube 130, a layer of thermal insulation 146 may be added to tube 130. As an added benefit, this material of insulation 146 may be chosen to have adequate stiffness so as to maintain tub 130 in an open configuration even if blower 136 is off. Alternatively, insulation 146 maybe itself bridge the gap between the curtain and the wall. This may allow continued environmental/thermal separation between the warm and cold sides of the opening in the event of a door power failure.

Although the invention is described with respect to various embodiments, modifications thereto will be apparent to those of ordinary skill in the art. The scope of the invention, therefore, is to be determined by reference to the following claims:

1. A door comprising:
a flexible panel that is movable between an open position and a closed position to respectively open and close the door, the flexible panel includes a first sheet and a second sheet that define a chamber therebetween, wherein the chamber contains a fluid whose pressure would tend to increase as the door opens in the absence of additional structure; and
a means for at least one of preventing or relieving the pressure increase in the chamber.

2. The door of claim 1, wherein the flexible panel moves vertically and bends as the door opens and closes.

3. The door of claim 1, wherein the means for at least one of preventing or relieving the pressure comprises a pump in fluid communication with the chamber when the flexible panel is at the closed position.

4. The door of claim 3, further comprising a coupling that selectively connects and disconnects the pump in fluid communication with the chamber.

5. The door of claim 3, wherein the pump is disposed within the chamber.

6. The door of claim 1, wherein the means for at least one of preventing or relieving the pressure comprises a check valve in fluid communication with the chamber, wherein the check valve provides more restriction to the fluid entering the chamber than leaving the chamber.

7. The door of claim 1, further comprising:
a layer of insulation disposed within the chamber; and
a vertically elongate rib disposed within the chamber such that the vertically elongate rib and the layer of insulation define an air passageway therebetween, the air passageway thus forming a part of the means for at least one of preventing or relieving the pressure.

8. The door of claim 1, further comprising a layer of insulation interposed between the first sheet and the second sheet, wherein the flexible panel moves vertically and bends as the door opens and closes, the flexible panel includes a central region lined by a generally rectangular peripheral edge that joins the first sheet to the second sheet, the first sheet and the second sheet are spaced apart from each other across substantially the entire central region so that the first sheet and the second sheet can translate relative to each other across substantially the entire central region.

9. The door of claim 1, further comprising:
a layer of insulation disposed within the chamber, wherein the layer of insulation comprises an upper half and a lower half; and
an adhesive that bonds the layer of insulation to at least one of the first sheet and the second sheet, wherein more of the adhesive is on the upper half of the layer of insulation than is on the lower half.

10. The door of claim 1, further comprising:
a layer of insulation disposed within the chamber; and
an adhesive that bonds the layer of insulation to at least one of the first sheet and the second sheet, wherein more of the adhesive is on the first sheet than is on the second sheet.

11. The door of claim 1, further comprising:
a layer of insulation disposed within the chamber; and
a roller that is rotatable about a substantially horizontal axis, the flexible panel bends at the roller as the door opens and closes such that an outer surface of the roller compresses the flexible panel where the flexible panel contacts the roller, the outer surface of the roller includes a major diameter section and a minor diameter section, wherein the flexible panel becomes compressed more at the major diameter section than at the minor diameter section to allow creation of an air passageway in the chamber, the passageway thus forming a part of the means for at least one of preventing or relieving the pressure.

12. The door of claim 1, further comprising:
a track that guides the flexible panel between the open position and the closed position;
a layer of insulation disposed within the chamber; and
an inflatable seal engaging the flexible panel, the inflatable seal defines an air discharge outlet that directs air toward the track.

13. The door of claim 1, wherein the means for at least one of preventing or relieving the pressure comprises a mass being suspended from the first sheet and the second sheet, wherein the first sheet and the second sheet extend across an upper section and a lower section of the flexible panel, and the mass is interposed between the upper section and the lower section such that when the door is closed, the weight of the mass places the lower section in compression and the upper section in tension, thereby urging the first sheet and the second sheet in the upper section of the flexible panel to be in substantially parallel relationship to each other.

14. A method of operating a door for selectively closing off and opening a doorway, comprising the steps of:
a) providing a door panel movable between and open and closed position with an internal chamber;
b) moving the door to the closed position;
c) placing a pump in fluid communication with the chamber
d) evacuating air from the chamber, and
e) moving the door to the open position.

15. The method of claim 14, wherein steps b) and c) are performed substantially simultaneously.

16. A door comprising:
a flexible panel that is movable between an open position and a closed position to respectively open and close the door, the flexible panel includes a first sheet and a second sheet that define a chamber therebetween; and
a pump in fluid communication with the chamber to evacuate air therefrom.

17. A door exposed to air, the door comprising:
a flexible panel that is movable between an open position and a closed position to respectively open and close the door, the flexible panel includes a first sheet and a second sheet that define a chamber therebetween; and
a check valve in fluid communication with the chamber, wherein the check valve provides more restriction to the air entering the chamber than leaving the chamber.

18. A door comprising:
a flexible panel that is movable between an open position and a closed position to respectively open and close the door, the flexible panel includes a first sheet and a second sheet that define a chamber therebetween;
a layer of insulation disposed within the chamber; and
a vertically elongate rib disposed within the chamber such that the vertically elongate rib and the layer of insulation define an air passageway therebetween.

19. A door comprising:
a flexible panel that is movable between an open position and a closed position to respectively open and close the door, the flexible panel includes a first sheet, a second sheet, and a layer of insulation therebetween wherein the layer of insulation is coupled adjacent its upper edge to at least one of the first and second sheet so as to be suspended therefrom.

20. The door of claim 19, wherein the layer of insulation comprises an upper half and a lower half; and an adhesive bonds the layer of insulation to at least one of the first sheet and the second sheet, wherein more of the adhesive is on the upper half of the layer of insulation than is on the lower half.

21. The door of claim 19, wherein an adhesive bonds the layer of insulation to at least one of the first sheet and the second sheet, wherein more of the adhesive is on the first sheet than is on the second sheet.

22. A door comprising:
a flexible panel that is movable between an open position and a closed position to respectively open and close the door, the flexible panel includes a first sheet, a second sheet, and a layer of insulation therebetween, and
a roller that is rotatable about a substantially horizontal axis, the flexible panel bends at the roller as the door opens and closes such that an outer surface of the roller compresses the flexible panel where the flexible panel contacts the roller, the outer surface of the roller includes a major diameter section and a minor diameter section, wherein the flexible panel becomes compressed more at the major diameter section than at the minor diameter section.

23. A door exposed to air, the door comprising:
a track;
a flexible panel engaging the track, wherein the track guides the flexible panel between an open position and a closed position to respectively open and close the door; and
an inflatable seal engaging the flexible panel, the inflatable seal defines an air discharge outlet that directs the air toward the track.

24. A door comprising:
a flexible panel that is movable between an open position and a closed position to respectively open and close the door, the flexible panel includes an upper section and a lower section, the flexible panel includes a first sheet and a second sheet that define a chamber therebetween; and
a mass being suspended from the first sheet and the second sheet and being interposed between the upper section and the lower section of the flexible panel such that when the door is closed, the weight of the mass places the lower section in compression and the upper section in tension, thereby urging the first sheet and the second sheet in the upper section of the flexible panel to be in substantially parallel relationship to each other.

25. A method of operating a door for selectively closing off and opening a doorway, comprising the steps of:
a) moving a door panel with an internal chamber between open and closed positions relative to the doorway;
b) placing a pump in fluid communication with the chamber; and
c) evacuating air from the chamber either during movement, at the open or closed position, or both.
